(19) United States
(12) Patent Application Publication
(10) Pub. No.: US 2018/0279729 A1
(43) Pub. Date: Oct. 4, 2018

(54) Leather Case and Keyboard Assembly for Tablet Computer

(71) Applicant: Shenzhen Neostra Technology Co., Ltd., Shenzhen (CN)

(72) Inventor: Aimin HU, Shenzhen (CN)

(73) Assignee: Shenzhen Neostra Technology Co., Ltd.

(21) Appl. No.: 15/808,734

(22) Filed: Nov. 9, 2017

(30) Foreign Application Priority Data
Apr. 1, 2017 (CN) 201720340826.1

(51) Int. Cl. A45C 11/00; G06F 1/16; G06F 3/02

(52) U.S. Cl. CPC A45C 11/00; G06F 1/1626; A45C 2200/15; A45C 2011/003; G06F 3/0202

(57) ABSTRACT

A leather case and keyboard assembly for tablet computer which includes a keyboard unit, and a support unit connected to the keyboard unit. The support unit comprises a fixed portion and a rotatable portion connected to the fixed portion by a rotating shaft while the fixed portion is connected to the keyboard unit. The fixed portion and the rotatable portion of the support unit are connected through a rotating shaft while the rotational angle of the fixed portion with respect to the rotatable portion is 0-180 degree. When the leather case and keyboard assembly is under an in-use condition and an external force is applied, the rotatable portion will rotate with respect to the fixed portion until the two portions are in parallel, thus damages to the support unit and the keyboard unit by external pressing force is prevented effectively.

### BACKGROUND OF THE PRESENT INVENTION

### Field of Invention

The present invention relates to an accessory of tablet computer and, more particularly to a leather case and keyboard assembly for table computer which is capable of providing a keyboard and acting as a support to the tablet computer while the support is rotatable and is not easy to damage.

### Description of Related Arts

The existing leather case and keyboard assemblies provide a single angle and the majority of which support the tablet computer through folding the leather case, or through a shaft, which fail to meet the different requirements of different users. In addition, the shaft being used in the market is not flexible and the shaft or the shaft for the keyboard accessory is easy to damage by external force when in use.

### SUMMARY OF THE PRESENT INVENTION

In order to overcome the problems of existing arts, an object of the present invention is to provide a leather case and keyboard assembly which comprises a rotating shaft on its support unit such that when the leather case and keyboard assembly is pressed by an external force, the rotatable portion will rotate with respect to the fixed portion to prevent damages to the leather case and keyboard assembly.

Additional advantages and features of the invention will become apparent from the description which follows, and may be realized by means of the instrumentalities and combinations particular point out in the appended claims.

According to the present invention, the foregoing and other objects and advantages are attained by a leather case and keyboard assembly for tablet computer which comprises a keyboard unit, wherein the leather case and keyboard assembly comprises a support unit connected to the keyboard unit, the support unit comprises a fixed portion and a rotatable portion connected to the fixed portion by a rotating shaft, the fixed portion is connected to the keyboard unit.

Preferably, the rotatable portion rotates with respect to the fixed portion, the rotatable portion supports the fixed portion when the rotatable portion stops rotational movement defining a stop position at which an angle α between the fixed portion and the rotatable portion is defined, where the angle α has a range between 100 and 180 degrees.

Preferably, the fixed portion has a connecting surface made of non-slip material arranged for direct contact with the table computer.

Preferably, the rotatable portion has a free end and a notch is provided inside an inner side of the free end of the rotatable portion.

The advantageous effect of the present invention is that the fixed portion and the rotatable portion of the support unit are connected through a rotating shaft. Also, the rotational angle of the fixed portion with respect to the rotatable portion is 0-180 degree. Therefore, when using the leather case and keyboard assembly and an external force is applied to the leather case and keyboard assembly, the rotatable portion will rotate with respect to the fixed portion until the two portions are in parallel. Accordingly, damages to the support unit and the keyboard unit which is caused by external pressing is prevented effectively.

Still further objects and advantages will become apparent from a consideration of the ensuing description and drawings. These and other objectives, features, and advantages of the present invention will become apparent from the following detailed description, the accompanying drawings, and the appended claims.

### BRIEF DESCRIPTION OF THE DRAWINGS

FIG. 1 is a rear view of a leather case and keyboard assembly for table computer according to a preferred embodiment of the present invention.

FIG. 2 is a left side view illustration of the leather case and keyboard assembly for table computer according to the above preferred embodiment of the present invention.

FIG. 3 is an illustration of the leather case and keyboard assembly for table computer according to the above preferred embodiment of the present invention.

FIG. 4 is another illustration of the leather case and keyboard assembly for table computer according to the above preferred embodiment of the present invention.

### DETAILED DESCRIPTION OF THE PREFERRED EMBODIMENT

The preferred embodiment of the present invention is further described with the accompanying drawings as follows and is not intended to be limiting.

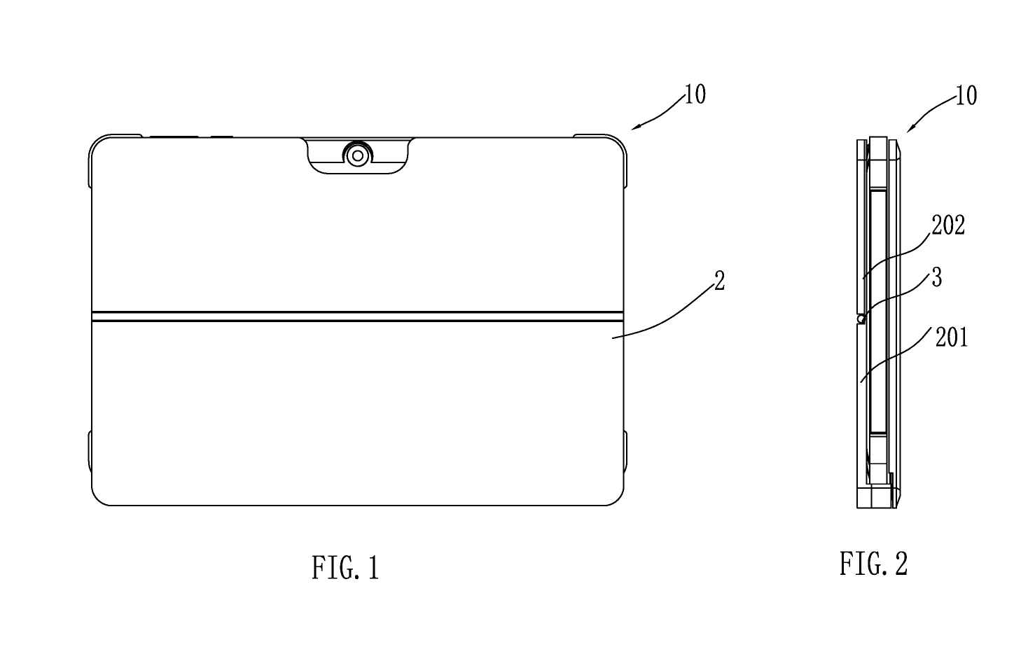

Referring to FIG. 1 to FIG. 4 of the drawings, a leather case and keyboard assembly for table computer 10 according to a preferred embodiment of the present invention comprises a keyboard unit 1, and a support unit 2 connected to the keyboard unit 1. The support unit 2 comprises a fixed portion 201 and a rotatable portion 202, and the fixed portion 201 and the rotatable portion 202 are connected through a rotating shaft 3. The fixed portion 201 is connected to the keyboard unit 1.

The rotatable portion 202 can rotate with respect to the fixed portion 201. When the rotatable portion 202 stops rotational movement and defines a stop position, the rotatable portion 202 can support the fixed portion 201 and the angle α between the rotatable portion 202 and the fixed portion 201 at the stop position is between 100 and 180 degrees.

The fixed portion 201 has a connecting surface 2011 made of non-slip material arranged for direct contact with the table computer 4 and a friction between the tablet computer and the fixed portion 201 is increased.

The rotatable portion 202 has a free end and a notch 202a is provided inside an inner side of the free end 2021 of the rotatable portion 202.

The support unit 2 is formed by the fixed portion 201 and the rotatable portion 202 and the fixed portion 201 and the rotatable portion 202 are connected through a rotating shaft 3. The fixed portion can rotate with respect to the rotatable portion and the angle of rotation is between 0-180 degree. Under an in-use condition, if an external force is applied to the leather case and keyboard assembly, the rotatable portion will rotate with respect to the fixed portion until the two portions are aligned in parallel. Therefore, damages to the support unit and the keyboard unit due to external force are effectively prevented.

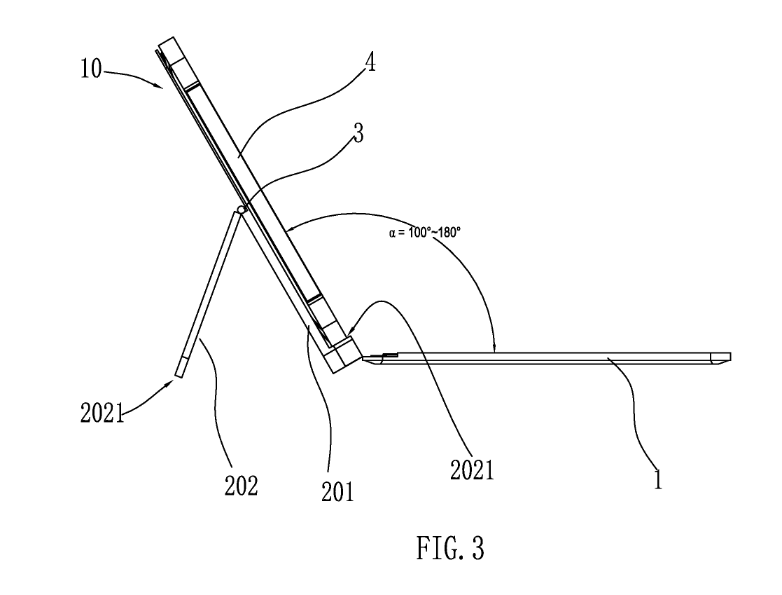

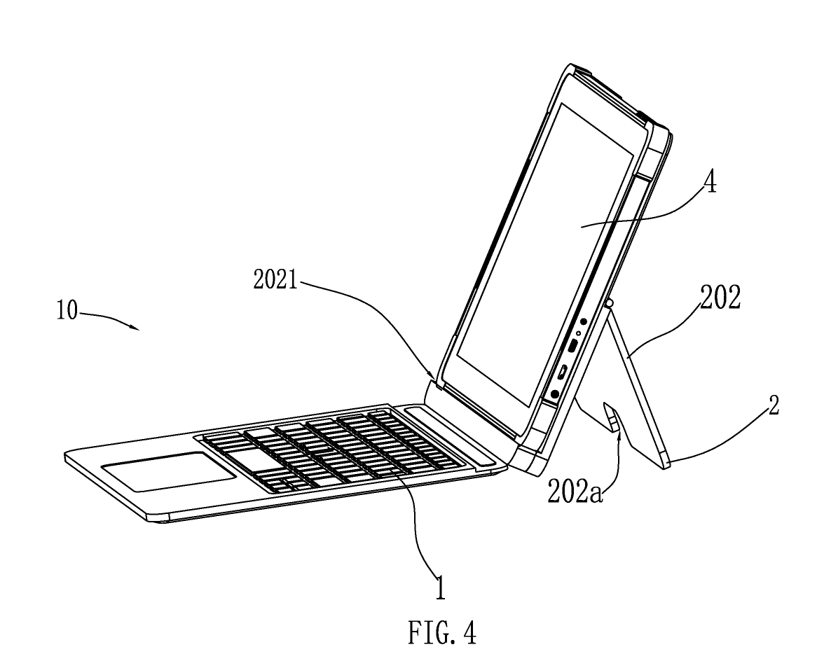

Preferably, as shown in FIG. 3 and FIG. 4 of the drawings, the leather case and keyboard assembly for table computer 10 is used to support a tablet computer 4. The leather case and keyboard assembly for table computer 10 comprises a keyboard unit 1 and a support unit 2 connected to the keyboard unit 1. The support unit 2 comprises a fixed portion 201 and a rotatable portion 202. The fixed portion 201 and the rotatable portion 202 are connected together through a rotating shaft 3. The fixed portion 201 has one side connecting to the keyboard unit 1 and another opposing side connecting to the rotatable portion 202. The fixed portion and the rotatable portion are made of leather materials or imitative leather materials.

The rotatable portion 202 can rotate with respect to the fixed portion 201. When the rotatable portion 202 stops rotational movement and defines a stop position, the rotatable portion 202 can support the fixed portion 201 and the angle α between the rotatable portion 202 and the fixed portion 201 at the stop position is between 100 and 180 degrees. In other words, the tablet computer 4, which is supported through the fixed portion 201 and is arranged to move together with the fixed portion 201, is capable of being support by the support unit 2 with an angle between 100 and 180 degrees relative to the keyboard unit 1.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A leather case and keyboard assembly for tablet computer which comprises a keyboard unit, characterized in that: said leather case and keyboard assembly comprises a support unit connected to said keyboard unit, said support unit comprises a fixed portion and a rotatable portion connected to said fixed portion by a rotating shaft, said fixed portion is connected to said keyboard unit.

2. The leather case and keyboard assembly for tablet computer according to claim 1, wherein said rotatable portion rotates with respect to said fixed portion, said rotatable portion supports said fixed portion when said rotatable portion stops rotational movement defining a stop position at which an angle α between said fixed portion and said rotatable portion is defined, where said angle α has a range between 100 and 180 degrees.

3. The leather case and keyboard assembly for tablet computer according to claim 2, wherein said fixed portion has a connecting surface made of non-slip material arranged for direct contact with the table computer.

4. The leather case and keyboard assembly for tablet computer according to claim 2, wherein said rotatable portion has a free end and a notch is provided inside said free end of said rotatable portion.

5. The leather case and keyboard assembly for tablet computer according to claim 1, wherein said fixed portion and said rotatable portion are made of leather materials or imitative leather materials.
